(19) United States
(12) Patent Application Publication
(10) Pub. No.: US 2016/0172828 A1
(43) Pub. Date: Jun. 16, 2016

(54) Wire Stripping Tool

(71) Applicant: HANLONG INDUSTRIAL CO., LTD., New Taipei City (TW)

(72) Inventor: Chien-Chou Liao, New Taipei City (TW)

(21) Appl. No.: 14/622,968

(22) Filed: Feb. 16, 2015

(30) Foreign Application Priority Data
Dec. 11, 2014 (TW) 103222012

(51) Int. Cl. H02G 1/12

(52) U.S. Cl. CPC H02G 1/1212

(57) ABSTRACT

A wire stripping tool comprises a first clip body, a second clip body, an adjusting device, a blade, and a retractable seat. The first clip body includes a first front end with an accommodating groove disposed on one side. The second clip body and the first clip body are coupled to each other. The second clip body includes a second front end with a through hole disposed thereon. The adjusting device is connected to the second clip body, and a part of the adjusting device is disposed within the through hole. The blade is connected to the part being disposed within the through hole. The adjusting device is used to adjust the length of the blade exposed by the through hole. The retractable seat is combined into the accommodating groove for placing wires.

### BACKGROUND OF THE INVENTION

1. Field of the Invention

The present invention relates to a wire stripping tool, particularly to a wire stripping tool which enables users to precisely strip an outer layer of a wire.

2. Description of the Related Art

In general, a signal wire or a power wire is covered with an outer layer to protect a transmission body of the signal wire or the power wire. However, when the wires are used, sometimes it is necessary to strip an outer layer to meet certain requirements, and therefore there will be a variety of wire strippers.

FIG. 1 presents a partial enlarged schematic view illustrating a traditional wire stripper. Although the stripper allows users to easily strip an outer layer 91 of a wire 90, due to the varying thicknesses of the wire 90, as shown in FIG. 1, when the wire 90 is placed into an arcuate recess 112a of the first clip body 10a, the wire 90 will be a distance away from one side of the second clip body 20a. When the blade 40a is pressed against the wire 90 and the user rotates the stripper so that the blade 40a will cut off an outer layer 91 of the wire 90, the wire 90 cannot abut against one side of the second clip body 20a, so a transmission body of the wire 90 is often damaged during rotation because the wire 90 is cut too deeply by the up and down movement of the blade 40a.

### SUMMARY OF THE INVENTION

It is a primary objective of the present invention to provide a wire stripping tool capable of precisely stripping the outer layer of wire.

To achieve the aforementioned objective, the wire stripping tool of the present invention includes a first clip body, a second clip body, an adjusting device, a blade, and a retractable seat. The first clip body includes a first front end, and one side of the first front end includes an accommodating groove. The second clip body and the first clip body are pivotally connected to each other. The second clip body includes a second front end on which a through hole is disposed. The through hole substantially corresponds to the accommodating groove. The adjusting device is connected to the second clip body, and one part thereof is disposed within the through hole. The blade is connected to the part of the adjusting device disposed within the through hole. The adjusting device is used to adjust the length of the blade exposed by the through hole. The retractable seat is combined into the accommodating groove for placing a wire. When the first front end of the first clip body and the second front end of the second clip body are clamped together, the wire is pressed against one side of the second front end through an elastic force provided by the retractable seat.

According to an embodiment of the present invention, the retractable seat includes a seat body and an elastic member. The elastic member is connected to the seat body for providing the elastic force.

According to an embodiment of the present invention, the elastic member is a tension spring.

According to an embodiment of the present invention, the seat body includes a hook, and the accommodating groove includes a stop wall. The hook is used to snap the stop wall.

According to an embodiment of the present invention, the adjusting device includes an adjusting knob and a screw. The adjusting knob has a screw hole. The screw is disposed within the through hole. One end of the screw is connected to the screw hole, and the opposite end of the screw is connected to the blade. The adjusting knob adjusts the length of the blade exposed by the through hole by adjusting the length of the screw protruding from the screw hole.

According to an embodiment of the present invention, the wire stripping tool of the present invention further includes an elastic element. One end of the elastic element is connected to the first clip body, and the opposite end of the elastic element is connected to the second clip body. The elastic element is used to maintain the clamping action of the first front end of the first clip body and the second front end of the second clip body.

### BRIEF DESCRIPTION OF THE DRAWINGS

FIG. 1 shows a conventional stripping tool;

FIG. 2 is a top view of a wire stripping tool according to the present invention;

FIG. 3 is an exploded view of a wire stripping tool according to the present invention;

FIG. 4 is a lateral view of a wire stripping tool according to the present invention;

FIG. 5A is a partially sectional side view of a wire stripping tool for stripping wires with a larger aperture according to the present invention; and

FIG. 5B is a partially sectional side view of a wire stripping tool for stripping wires with a smaller aperture according to the present invention.

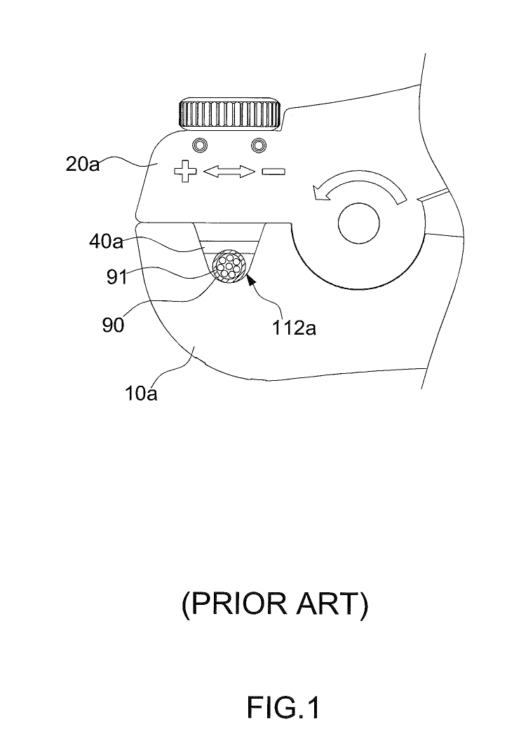

### DETAILED DESCRIPTION OF THE PREFERRED EMBODIMENT

The technical content of the present invention will become apparent with reference to preferred embodiments as described hereinafter.

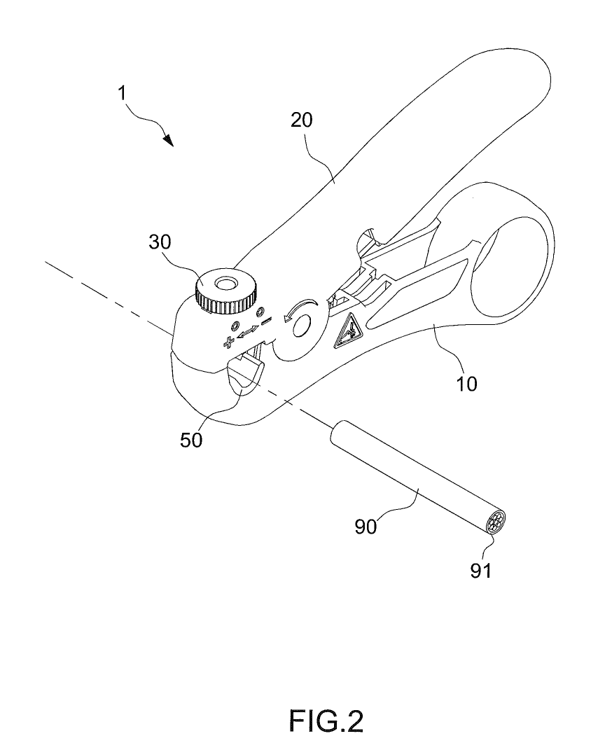

Please refer now to FIG. 2 to FIG. 5, which illustrate a schematic view of a wire stripping tool according to the present invention.

As shown in FIG. 2, the wire stripping tool 1 of the present invention is used to strip an outer layer 91 of a wire 90. In a specific embodiment of the present invention, the wire 90 is a signal wire or a power wire, but the present invention is not limited thereto.

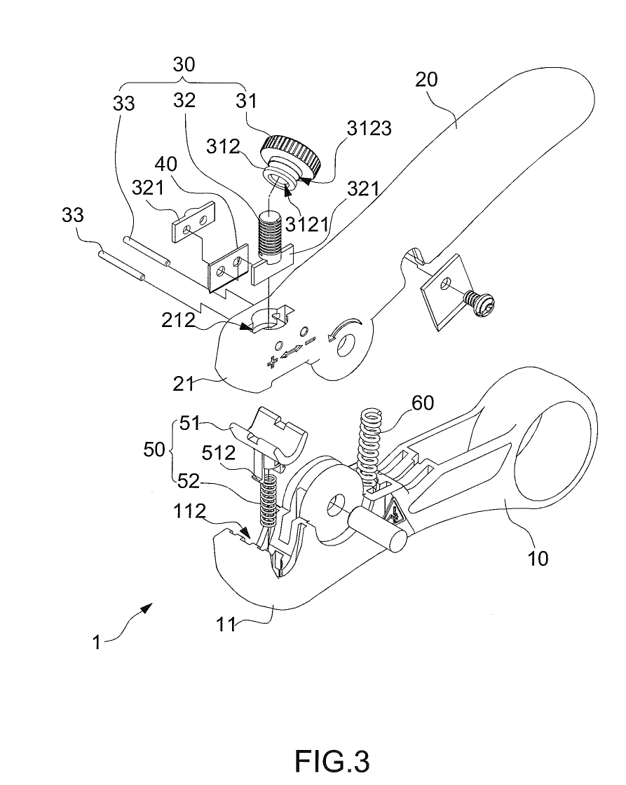

As shown in FIG. 3, in an embodiment of the present invention, the wire stripping tool 1 of the present invention includes a first clip body 10, a second clip body 20, an adjusting device 30, a blade 40, a retractable seat 50, and an elastic element 60.

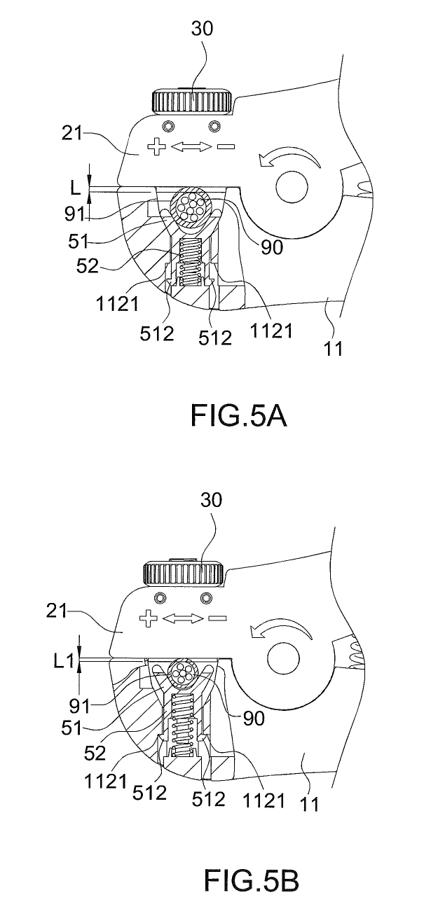

In an embodiment of the present invention, the first clip body 10 includes a first front end 11, and there is an accommodating groove 112 at one side of the first front end 11, wherein the accommodating groove 112 has a pair of stop walls 1121 (as shown in FIG. 5A).

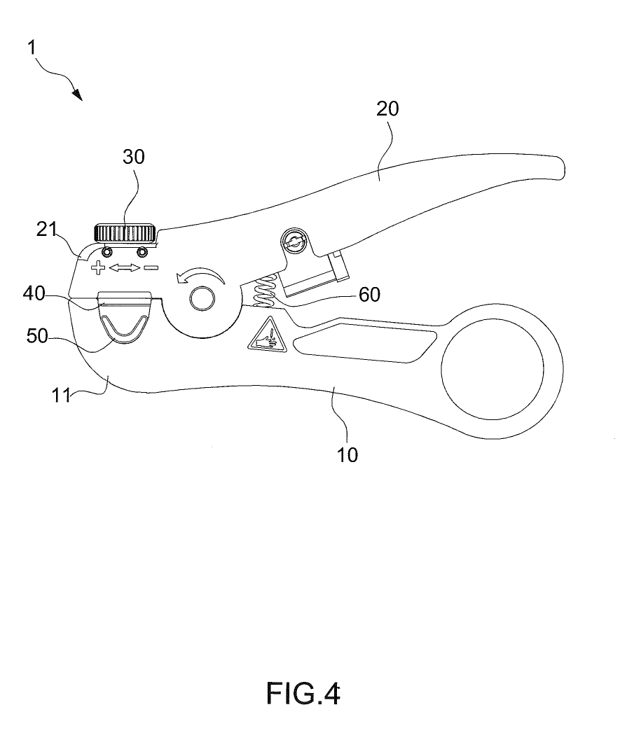

As shown in FIGS. 3 and 4, in an embodiment of the present invention, the second clip body 20 and the first clip body 10 are pivotally connected to each other. The second clip body 20 includes a second front end 21, on which a through hole 212 is disposed. The through hole 212 substantially corresponds to the accommodating groove 112.

In an embodiment of the present invention, the adjusting device 30 includes an adjusting knob 31, a screw 32, and a pair of bolts 33. The adjusting knob 31 has a stud 312 which includes a screw hole 3121 and a recessed ring 3123. The screw 32 is inserted into the through hole 212, and the end of the screw 32 having threads is coupled to the screw hole 3121. That is, one end of the screw 32 is connected to the adjusting knob 31, and the opposite end of the screw 32 is provided with a pair of coupling portions 321. The bolt 33 is inserted into the through hole 212 through the opening (not shown) on the second front end 21 of the second clip body 20 and snapped into the recessed ring 3123 of the stud 312 such that the adjusting knob 31 is prevented from moving up and down and can only be rotated.

In an embodiment of the present invention, the blade 40 is connected to the coupling portion 321 of the adjusting device 30. The two coupling portions 321 can be used to hold and fasten the blade 40. With the above design of the mechanism, when the user rotates the adjusting knob 31, the bolt 33 will prevent the adjusting knob 31 from moving up and down, and the screw 32 inserted into the through hole 212 can be displaced up and down only when the adjusting knob 31 is rotated; through the screwing action between the screw hole 3121 and the screw 32, the screw 32 and the blade 40 can be moved up and down to adjust the length of the blade 40 exposed by the through hole 212. That is, the adjusting device 30 can be used here to adjust the length of the blade 40 exposed by the through hole 212. It should be noted here that the adjusting device 30 of the wire stripping tool 1 of the present invention is not limited to the aforementioned mechanism. Any existing mechanism that can adjust the telescopic length of an object can be used as the adjusting device 30 in the present invention.

In an embodiment of the present invention, the retractable seat 50 is combined and disposed in the accommodating groove 112. The retractable seat 50 includes a seat body 51 and an elastic member 52. The seat body 51 includes a pair of hooks 512. Each of the hooks 512 is used for being snapped into the stop wall 1121 within the accommodating groove 112 to prevent the retractable seat 50 from detaching from the accommodating groove 112. One end of the elastic member 52 is connected to the seat body 51, and the opposite end of the elastic member 52 is connected to the first front end 11 of the first clip body 10 and fixed into the accommodating groove 112. The elastic member 52 is used for providing an elastic force for the seat body 51: In a specific embodiment of the present invention, the elastic member 52 is a tension spring, but the present invention is not limited thereto.

In an embodiment of the present invention, one end of the elastic element 60 is connected to the first clip body 10, and the opposite end of the elastic element 60 is connected to the second clip body 20. The elastic element 60 is used to maintain the clamping of the first front end 11 of the first clip body 10 and the second front end 21 of the second clip body 20. In a specific embodiment of the present invention, the elastic element 60 is a tension spring, but the present invention is not limited thereto.

As shown in FIG. 5A, when the user places the wire 90 on the seat body 51 of the retractable seat 50, the elastic member 52 applies an elastic force to the seat body 51 (i.e., toward the direction of the second clip body 20); in the process of removing the outer layer 90, the top of the wire 90 will abut against one side of the second front end 21 of the second clip body 20. In other words, the wire 90 will be clamped and fixed by the second clip body 20 and the retractable seat 50. Thus, as long as the user adjusts the length L of the blade 40 exposed by the through hole 212 such that it is the same thickness as the outer layer 91 of the wire 90, the user can precisely strip the whole layer of the outer layer 91 without damaging the transmission body of the wire 90 (because the wire 90 has been held and fixed, it does not move up and down). As shown in FIG. 5B, in the case the thickness of the wire 90 to be handled is smaller, the wire 90 can also be positioned against one side of the second front end 21 of the second clip body 20 due to the elastic force applied by the elastic member 52. Therefore, in a similar way, the user can just adjust the length L1 of the blade 40 exposed by the through hole 212 such that it is the same as the thickness of the outer layer 91 of the wire 90 in order to precisely strip the whole layer of the outer layer 91.

As described above, the objective, means, and efficiency of the present invention all differ from conventional characteristics of the prior art. It should be noted that the described embodiments are only for illustration and exemplification, and the scope of the claims as claimed in the present invention is as disposed by the appended claims and not limited to the aforementioned embodiments.

What is claimed is:

1. A wire stripping tool used for stripping an outer layer of a wire, the wire stripping tool comprising:
a first clip body, comprising a first front end with an accommodating groove disposed on one side thereof;
a second clip body, pivotally connected to the first clip body, the second clip body comprising a second front end, and the second front end having a through hole, the through hole substantially corresponding to the accommodating groove;
an adjusting device, connected to the second clip body, and a part of the adjusting device is disposed within the through hole;
a blade, which is connected to the part of the adjusting device disposed within the through hole, and the adjusting device is used for adjusting the length of the blade exposed by the through hole; and
a retractable seat, which is combined into the accommodating groove for placing the wire; when the first front end of the first clip body and the second front end of the second clip body are clamped together, the wire is positioned against one side of the second front end through an elastic force provided by the retractable seat.

2. The wire stripping tool as claimed in claim 1, wherein the retractable seat comprises a seat body and an elastic member; the elastic member is connected to the seat body, and the elastic member is used for providing the elastic force.

3. The wire stripping tool as claimed in claim 2, wherein the elastic member is a tension spring.

4. The wire stripping tool as claimed in claim 3, wherein the seat body comprises at least a hook, and there is at least one stop wall in the accommodating groove, the at least one hook being used to snap the at least one stop wall.

5. The wire stripping tool as claimed in claim 1, wherein the adjusting device comprises an adjusting knob and a screw, the adjusting knob having a screw hole, the screw being disposed within the through hole; one end of the screw is connected to the screw hole, and the opposite end of the screw is connected to the blade; the adjusting knob adjusts the length of the blade exposed by the through hole through adjusting the length of the screw protruding from the screw hole.

6. The wire stripping tool as claimed in claim 1, further comprising an elastic element, wherein one end of the elastic element is connected to the first clip body, and the opposite end of the elastic element is connected to the second clip body; the elastic element maintains the clamping of the first front end of the first clip body and the second front end of the second clip body.
